(19) United States
(12) Patent Application Publication
(10) Pub. No.: US 2026/0092666 A1
(43) Pub. Date: Apr. 2, 2026

(54) PLUMBING FITTING AND SEAT

(71) Applicant: M & B Product Innovation Pty Ltd, Melbourne, Victoria (AU)

(72) Inventors: William Breen, Blackburn, Victoria (AU); Mario Vallese, Tullamarine, Victoria (AU)

(21) Appl. No.: 19/110,617

(22) PCT Filed: Jul. 26, 2023
(86) PCT No.: PCT/AU2023/050679

§ 371 Date: Mar. 11, 2025

(30) Foreign Application Priority Data
Sep. 16, 2022 (AU) 2022902685
Jun. 23, 2023 (AU) 2023901982

(51) Int. Cl. F16L 43/02

(52) U.S. Cl. CPC F16L 43/02

(57) ABSTRACT

A plumbing fitting of the type used in a drainage system. The fitting has a body portion having a liquid inlet and a liquid outlet, and configured to alter the direction of a liquid being conveyed through it. The body portion includes a region that is resistant to fracture upon contact with a blockage clearing tool when used to clear a blockage therein.

### FIELD OF THE INVENTION

The present invention relates generally to the field of plumbing fittings. More particularly, the invention is directed to a plumbing fitting of the type used in a drainage system.

### BACKGROUND TO THE INVENTION

In drainage applications, a substantially vertical pipe may be connected to a substantially horizontal pipe using a connection fitting of some description. In that context, connection fittings often used in plumbing applications include but are not limited to: a boundary trap, a disconnector gully trap, a junction, an inspection piece, an elbow and a bend. Drainage water from a source (such as a sink, a bath, a shower recess, a toilet or a gutter), passes downwardly through the vertical pipe, and via a connection fitting to a horizontal pipe. Ultimately, the horizontal pipe discharges the drainage water into a sewer or stormwater.

Drainage systems may include fittings which connect two horizontal pipes, or two vertical pipes. In these arrangements, the connection fitting may be a junction, an inspection piece, and elbow or a bend.

Both the pipes and the connection fitting are typically fabricated from a robust plastic such as unplasticised polyvinyl chloride (UPVC), acrylonitrile butadiene styrene (ABS), or high density polyethylene (HDPE).

Even when fabricated using robust plastics, the connection fitting may be damaged during a blockage clearance procedure. A drain may become blocked with any material, including tile grout and cement (as sometimes occurs during building construction), organic material, sanitary items, wipes, children's toys and other foreign objects. The blockage may be removed by forcing a rigid rod downwardly through a pipe and toward to the connection fitting. The rod functions to break the blockage into small portions which can be effectively carried away by flushing with water. In other methods, the rod has a rubber disk at its terminus having a diameter about that of the internal diameter of the pipe, with downward movement of the rod causing a positive pressure which may clear the blockage. Impact of the rod with the pipe wall can lead to significant damage, including complete fracture so as to allow leakage of drainage water.

Tree roots are another cause of drain blockage. Typically a cutting machine is introduced into the drain to macerate the roots and return patency to the pipe. A problem arises where the cutting head impacts the wall of the connection fitting, again leading to damage.

In light of the potential for damage, building regulations often require that the connection fitting is embedded in concrete. Typically, a minimum of 100 mm of concrete is required beneath the bend and extending to embed also the inlet and outlet portions of the fitting. The concrete functions to resist the impact of any rod or other contrivance employed to clear a blockage.

In addition or alternatively, the concrete may function to support the weight of any pipes connected to the connection fitting. Particularly where a long vertical pipe is connected to the fitting, the pipe's weight may bear downwardly leading to movement in the fitting and therefore other connected components of the drainage system.

In any event, the need to embed a connecting fitting in concrete raises problems during installation of a drainage system. One problem is that concrete must be transported to the building site, and a water source must be at hand to mix with the dried concrete. Apart from the cost of labour and materials, occupational health and safety issues arise in respect of cement inhalation and injuries associated with the manual handling of heavy loads.

Another problem is that the concrete must be allowed to cure before the drainage ditch is back-filled, that process potentially slowing installation. A further problem is that the operator may not take sufficient care so as to ensure that the concrete is laid to a mandated thickness.

Prior artisans provide various means for supporting plumbing fittings so as to avoid the need for concrete embedment. Examples are disclosed in Australian Innovation Patent Publication 2019100419 A4. However, these support means do not always function as intended or required. Deficiencies in the prior art have been identified by the present inventors, with those deficiencies contributing to the features of the connection fittings described and claimed herein. As will be more fully detailed infra, the present inventors have identified hitherto unrecognised problems with prior art plumbing fittings with respect to impact resistance and stability at least.

A further problem arises in that significant amounts of material may be used in the fabrication of a plumbing fitting.

One aspect of the present invention is to provide an improvement in prior art plumbing fittings. In addition or alternatively, another aspect of the present invention is to provide a useful alternative to prior art plumbing fittings.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a plumbing fitting comprising a body portion having a liquid inlet and a liquid outlet, the body portion configured to alter the direction of a liquid being conveyed therethrough, wherein the body portion is, or comprises a region that is, resistant to fracture upon contact with a blockage clearing tool when used to clear a blockage therein.

In one embodiment of the first aspect, the resistance to fracture is sufficient such that cement, concrete, or a functionally equivalent material is not required to support the body portion.

In one embodiment of the first aspect, the resistance to fracture is sufficient such that cement, concrete, or a functionally equivalent material is not required in the course of installation.

In one embodiment of the first aspect, the resistance to fracture is provided in part, or completely, by a wall of the body portion being fabricated from a polymer of sufficient thickness.

In one embodiment of the first aspect, the wall of the body portion has a thickness of at least about 3 mm, 4 mm, 5 mm, 6 mm, 7 mm, 8 mm, 9 mm or 10 mm.

In one embodiment of the first aspect, the plumbing fitting comprises a supporting portion extending from the body portion, the resistance to fracture is provided at least in part by the supporting portion extending from the body portion.

In one embodiment of the first aspect, the supporting portion is integral with the body portion.

In one embodiment of the first aspect, the supporting portion is a solid body.

In one embodiment of the first aspect, the supporting portion comprises spaces configured to save in the amount of material used in fabrication and/or to save in weight.

In one embodiment of the first aspect, the supporting portion is formed from one or more downwardly extending members configured to transfer a force occasioned on the body portion by a blockage clearing tool to a substrate beneath the body portion.

In one embodiment of the first aspect, the one or more downwardly extending members form a framework.

In one embodiment of the first aspect, the framework is in the form of a lattice-like arrangement.

In one embodiment of the first aspect, the plumbing fitting comprises a base portion in association with the supporting portion, the body portion being maintained in spaced relation to the base portion

In one embodiment of the first aspect, supporting portion and/or the base portion provide or contributes one or more spaces configured to allow a filling material introduced about the plumbing fitting during installation to enter thereinto.

In one embodiment of the first aspect, the supporting portion and/or the base portion is/are configured to retain a filling material introduced about the plumbing fitting during installation.

In one embodiment of the first aspect, the one or more spaces are configured to allow the movement of the filling material introduced about the plumbing fitting during installation.

In one embodiment of the first aspect, the supporting portion is configured so as to not present a broad face directed in a manner that would prevent or inhibit the movement of a filling material introduced about the plumbing fitting during installation into a space of the supporting portion.

In one embodiment of the first aspect, the supporting portion comprises a plurality of framework members each of which has a broad face, and wherein each of the broad faces are generally arranged, aligned or angled to allow movement of a filling material into the spaces between the framework members.

In one embodiment of the first aspect, at least some or most of the plurality of frame members have a length or a width at least about 30%, 35%, 40%, 45%, 50%, 55%, 60%, 65%, 70%, 75%, 80%, 85%, 90% or 95% the width of the body portion.

In one embodiment of the first aspect, each of the body portion, the supporting portion, and the base portion has a foot print in plan view, and
the base portion footprint is at least about 100%, 105%, 110%, 115%, 120%, 125%, 130%, 135%, 140%, 145%, 150%, 155%, 160%, 165%, 175%, 180%, 185%, 190%, 195% and 200% the footprint of the body portion, or the supporting portion.

In one embodiment of the first aspect, in plan view the majority of body portion footprint is located within the majority of the base portion footprint.

In one embodiment of the first aspect, in plan view the body portion is generally central to the base portion, or is generally aligned to the base portion.

In one embodiment of the first aspect, a wall region of the body portion facing toward the supporting portion or the base portion has a wall thickness of at least about 3 mm, 4 mm, 5 mm, 6 mm, 7 mm, 8 mm, 9 mm or 10 mm.

In one embodiment of the first aspect, a wall region of the body portion facing toward the supporting portion or the base portion has a wall thickness that is about the same or greater than the wall thickness of an opposing wall of the body portion.

In one embodiment of the first aspect, the plumbing fitting is configured to connect two conduits.

In one embodiment of the first aspect, the plumbing fitting is configured to alter the direction of the flow of liquid originating in one of the two conduits, or to divide the liquid originating in one of the two conduits, or to allow the inspection of liquid originating in one of the two conduits.

In one embodiment of the first aspect, the plumbing fitting is selected from: a boundary trap, a disconnector gully trap, a junction, an elbow, a bend and an inspection piece.

In one embodiment of the first aspect, the filling material is a particulate material.

In one embodiment of the first aspect, the particulate material is composed of particles having a maximum dimension of no larger than about 10 mm and/or no smaller than about 7 mm.

In one embodiment of the first aspect, the filling material is selected from: scoria, blue metal, quarter minus, sewer drain bedding rock, and aggregate.

In one embodiment of the first aspect, the supporting portion is integral with the body portion, and/or the supporting portion is integral with the base portion.

In one embodiment of the first aspect, the plumbing fitting is fabricated predominantly or completely from a synthetic polymer.

In one embodiment of the first aspect, the synthetic polymer is polyvinyl chloride (PVC), unplasticized polyvinyl chloride (UPVC), acrylonitrile butadiene styrene (ABS), fibre-reinforced plastic (FRP), or high density polyethylene (HDPE).

In one embodiment of the first aspect, the body portion is a plumbing conduit for use in a drainage application.

In one embodiment of the first aspect, the body portion is a bend or an elbow.

In one embodiment of the first aspect, the body portion, the supporting portion or the base portion comprises means to receive a support hanger.

In one embodiment of the first aspect, the means to receive a support hanger is an aperture, a recess or a lug.

In one embodiment of the first aspect, the plumbing fitting is configured such that a wall of the body portion and/or the supporting portion provides or contributes to resistance to fracture against a pressure or tension of at least about 10, 11, 12, 13, 14, 15, 16, 17, 18, 19, 20, 21, 22, 23, 24 or 25 MPa.

In one embodiment of the first aspect, the pressure or tension is applied over an area of between about 10 mm² to about 50 mm².

In one embodiment of the first aspect, the plumbing fitting, when installed on a substrate that is not concrete has at least the same or similar fracture resistance as a bend or a trap installed according to AS/NZS 3500.2 In a second aspect, the present invention provides a seat for supporting a plumbing conduit, the plumbing conduit having a liquid inlet and a liquid outlet, the plumbing conduit configured to alter the direction of a liquid being conveyed therethrough, the seat comprising a supporting portion, wherein the supporting portion is configured to confer on the plumbing conduit a resistance to fracture caused by contact with a blockage clearing tool when used to clear a blockage therein

In one embodiment of the second aspect, the resistance to fracture is sufficient such that cement, concrete, or a functionally equivalent material is not required to support the body portion.

In one embodiment of the second aspect, the resistance to fracture is sufficient such that cement, concrete, or a functionally equivalent material is not required in the course of installation.

In one embodiment of the second aspect, the resistance to fracture is provided in part, or completely, by a wall of the body portion being fabricated from a polymer of sufficient thickness.

In one embodiment of the second aspect, the supporting portion includes a contoured contact surface configured to conform to an external surface of the plumbing conduit.

In one embodiment of the second aspect, the supporting portion is a solid body.

In one embodiment of the second aspect, the supporting portion comprises spaces configured to save in the amount of material used in fabrication and/or to save in weight.

In one embodiment of the second aspect, the supporting portion is formed from one or more downwardly extending members configured to transfer a force occasioned on the body portion by a blockage clearing tool to a substrate beneath the body portion.

In one embodiment of the second aspect, the one or more downwardly extending members form a framework.

In one embodiment of the second aspect, the framework is in the form of a lattice-like arrangement.

In one embodiment of the second aspect, the seat comprises a base portion in association with the supporting portion, the body portion being maintained in spaced relation to the base portion

In one embodiment of the second aspect, the supporting portion and/or the base portion provide or contributes one or more spaces configured to allow a filling material introduced about the seat during installation to enter thereinto.

In one embodiment of the second aspect, the supporting portion and/or the base portion is/are configured to retain a filling material introduced about the seat during installation.

In one embodiment of the second aspect, the one or more spaces are configured to allow the movement of the filling material introduced about the seat during installation.

In one embodiment of the second aspect, the supporting portion is configured so as to not present a broad face directed in a manner that would prevent or inhibit the movement of a filling material introduced about the seat during installation into a space of the supporting portion.

In one embodiment of the second aspect, the supporting portion comprises a plurality of framework members each of which has a broad face, and wherein each of the broad faces are generally arranged, aligned or angled to allow movement of a filling material into the spaces between the framework members.

In one embodiment of the second aspect, at least some or most of the plurality of frame members have a length or a width at least about 30%, 35%, 40%, 45%, 50%, 55%, 60%, 65%, 70%, 75%, 80%, 85%, 90% or 95% the width of the body portion.

In one embodiment of the second aspect, each of the body portion, the supporting portion, and the base portion has a foot print in plan view, and the base portion footprint is at least about 100%, 105%, 110%, 115%, 120%, 125%, 130%, 135%, 140%, 145%, 150%, 155%, 160%, 165%, 175%, 180%, 185%, 190%, 195% and 200% the footprint of the body portion, or the supporting portion.

In one embodiment of the second aspect, in plan view the majority of body portion footprint is located within the majority of the base portion footprint.

In one embodiment of the second aspect, in plan view the body portion is generally central to the base portion, or is generally aligned to the base portion.

In one embodiment of the second aspect, the seat is configured to engage of a bend in a plumbing conduit.

In one embodiment of the second aspect, the filling material is a particulate material.

In one embodiment of the second aspect, the particulate material is composed of particles having a maximum dimension of no larger than about 10 mm and/or no smaller than about 7 mm.

In one embodiment of the second aspect, the filling material is selected from: scoria, blue metal, quarter minus, sewer drain bedding rock, and aggregate.

In one embodiment of the second aspect, the supporting portion is integral with the base portion.

In one embodiment of the second aspect, the seat is fabricated predominantly or completely from a synthetic polymer.

In one embodiment of the second aspect, the synthetic polymer is polyvinyl chloride (PVC), unplasticized polyvinyl chloride (UPVC), acrylonitrile butadiene styrene (ABS), fibre-reinforced plastic (FRP), or high density polyethylene (HDPE).

In one embodiment of the second aspect, the seat is configured to support a plumbing conduit for use in a drainage application.

In one embodiment of the second aspect, the plumbing conduit is a bend or an elbow.

In one embodiment of the second aspect, the supporting portion or the base portion comprises means to receive a support hanger.

In one embodiment of the second aspect, the means to receive a support hanger is an aperture, a recess or a lug.

In one embodiment of the second aspect, the seat is configured such that the supporting portion provides or contributes to resistance against a pressure or a tension of at least about 10, 11, 12, 13, 14, 15, 16, 17, 18, 19, 20, 21, 22, 23, 24 or 25 MPa to a plumbing conduit seated thereon.

In one embodiment of the second aspect, the pressure or the tension is applied over an area of between about 10 mm² to about 50 mm². In one embodiment of the second aspect, the seat, when installed on a substrate that is not concrete and having a plumbing conduit seated thereon, has at least the same or similar fracture resistance as a bend or a trap installed according to AS/NZS 3500.2.

In a third aspect, the present invention provides a method for installing a plumbing system or part thereof, the method comprising the steps of:
(i) providing the plumbing fitting of any embodiment of the first aspect,
(ii) locating supporting portion or the base portion of the plumbing fitting on a substrate, and
moving a filling material to a region about the supporting portion and/or about the base portion.

In a fourth aspect, the present invention provides a method for installing a plumbing system or part thereof, the method comprising the steps of:
(i) providing the seat of any embodiment of the second aspect,
(ii) locating the seat on a substrate, and
(iii) moving a filling material to a region about the supporting portion and/or about the base portion.

In one embodiment of the third aspect or the fourth aspect, the substrate is the floor of a trench.

In one embodiment of the third aspect or the fourth aspect, the filling material is a particulate material.

In one embodiment of the third aspect or the fourth aspect, the particulate material is composed of particles having a maximum dimension of no larger than about 10 mm and/or no smaller than about 7 mm.

In one embodiment of the third aspect or the fourth aspect, the particulate material is selected from: scoria, blue metal, quarter minus, sewer drain bedding rock, and aggregate.

In one embodiment of the third aspect or the fourth aspect, the filling material extends downwardly at least about 10, 20, 30, 40, 50, 60, 70, 80, 90 or 100 mm as measured from the lowest point of the plumbing fitting or the lowest point of a conduit supported by a seat.

In one embodiment of the third aspect or the fourth aspect the filling material extends laterally at least about 10, 20, 30, 40, 50, 60, 70, 80, 90 or 100 mm as measured from the most lateral point of the plumbing fitting or the most lateral point of a conduit supported by a seat.

In a fifth aspect, the present invention provides a method of installing a plumbing system of part thereof, the method comprising the steps of:
(i) providing the plumbing fitting of any embodiment of the first aspect having means to receive a support hanger, and
(ii) engaging the means to receive a support hanger with a support hanger.

In a sixth aspect, the present invention provides a method of installing a plumbing system of part thereof, the method comprising the steps of:
(i) providing the seat of any embodiment of the second aspect having means to receive a support hanger, and
(ii) engaging the means to receive a hanger with a support hanger.

In one embodiment of the fifth aspect or the sixth aspect, the support hanger is an elongate member.

In one embodiment of the fifth aspect or the sixth aspect, the elongate member is a rod or a bar.

In one embodiment of the fifth aspect or the sixth aspect the elongate member comprises a threaded section.

### BRIEF DESCRIPTION OF THE FIGURES

FIG. 1A illustrates an upper perspective view of a plumbing fitting of the present invention, specifically an elbow.

FIG. 1B illustrates a lateral view of the plumbing fitting of FIG. 1A.

FIG. 2 illustrates a lateral view of a plumbing fitting, showing (the shaded portion) the volume occupied by the present plumbing fitting in association with any filling material.

FIG. 3 illustrates a sectional perspective view of the plumbing fitting of FIG. 1A demonstrating a greater wall thickness in the outside radius of the plumbing fitting bend compared with the inside radius.

FIG. 4 illustrates a lower perspective view of the plumbing fitting of FIG. 1A, showing the apertures of the base portion extending through to the lower side thereof.

FIG. 5 illustrates in lateral view an alternative preferred plumbing fitting.

FIG. 6 illustrates highly diagrammatically the various layers of soil, filling material and backfill used in the installation of the elbow of FIG. 1A.

FIGS. 7A, 7B, 7C and 7D together illustrate an alternative preferred plumbing fitting having a base comprising more closely spaced frame members to better support a potential tool impact region of the pipe wall. FIG. 7A lateral perspective view, FIG. 7B lateral view, FIG. 7C lower perspective view, FIG. 7D lower view.

FIGS. 8A, 8B, 8C and 8D together illustrate an alternative preferred plumbing fitting being devoid of the sizeable base present in the earlier drawn embodiments. FIG. 8A lateral perspective view, FIG. 8B lateral view, FIG. 8C lower perspective view, FIG. 8D lower view.

FIGS. 9A, 8B, and 9C together illustrate a seat of the present invention. FIG. 9A and FIG. 9B (both perspective views) show respectively the conduit before contacting the seat, and the conduit being supported by the seat. FIG. 9C is a sectional lateral view of FIG. 9B.

FIG. 10 illustrates a trap installed according to AS/NZS 3500.2 (2018).

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, “vertical” “horizontal”, “plan view” and the like are to be considered with reference to an elbow drainage fitting as used in a normal upright position so as to channel water from a substantially vertical pipe to a substantially horizontal pipe.

As used herein, the term ‘fracture” is intended to include any disruption to a plumbing fitting (including a plumbing fitting body portion wall) that provides a portal for the egress of a liquid therefrom. Thus, a fracture may be a crack (whereby no material has been removed), or a hole (resulting from the removal of material), or any other disruption allowing leakage of fluid from the plumbing fitting.

The present invention is predicated at least in part on the inventors'discovery that failures of prior art plumbing fittings may be attributed to insufficient support to a wall of the plumbing fitting and/or insufficient filling material (such as scoria or blue metal) being retained about the fitting and/or the filling material being prone to shifting after installation. The end result in either scenario is that the plumbing fitting is not properly supported by the filling material, and therefore prone to damage by impact with a drain blockage clearing implement.

A further discovery is that prior art plumbing fittings allow water to collect about the base of the fitting after installation, thereby destabilising the fitting and allowing for undesired movement.

A further discovery is that a supported fitting nevertheless tends to sink under the weight of the vertical pipe, and or otherwise move. It is proposed that sinking or other movement may be due at least in part to the collection of water about the base as discussed immediately supra. Water collection allows for filling material to move about, and because the filling material acts to secure the elbow in place the elbow itself is allowed to move

The problem of movement has been found to manifest in the installer failing to correctly setting the fall of a horizontal pipe of a drainage system. The installer typically seeks to achieve a fall in the outlet pipes of 98% to allow for water to run one-way toward the sewer or storm water. The fall is measured very accurately, often with the assistance of a laser. However, with prior art fittings the accurately set fall may change before the installation is completed due to movement of the fitting during backfilling. For example, the connection fitting may move downwardly thereby lessening or obliterating the 98% fall set by the installer. The end result may be that waste water fails to properly drain from the horizontal pipe.

Any of these issues may be addressed by one or more embodiments of the present invention. Some embodiments of the invention do not address any of these issues and instead represent an unrelated improvement, or a useful alternative to prior art fittings.

The present invention provides in some embodiments means for supporting a plumbing bend above the floor of a drainage trench in a manner that allows for sufficient filling material to enter beneath the bend, and optionally to furthermore retain that filling material in place. The result is that the lower wall of the bend is well supported by the filling material over an extended period of time. The support beneath the lower wall lessens the chance of damage to that wall in the event of impact with a drain blockage clearing implement.

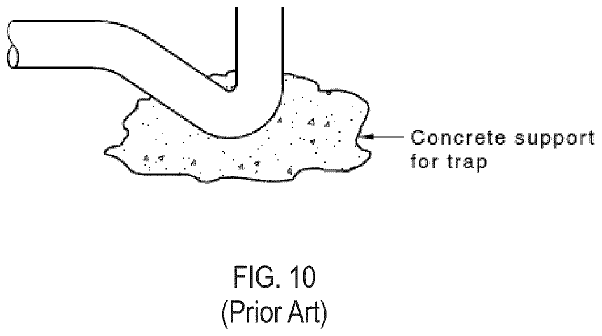

In some embodiments, the present invention provides a plumbing fitting having the same of similar resistance to fracture as a plumbing fitting that is supported according to Australian Standard/New Zealand standard 3500.2 (SAI Global, 2018) “Sanitary plumbing and drainage”. AS/NZS 3500.2 requires the use of a concrete support about a bend or a trap, as shown in FIG. 10 (prior art). Premixed concrete conforming to Australian Standard 1379 is specified, the concrete having a minimum compressive strength of 20 MPa. The concrete may be formed as a pad of at least about 100 mm thickness beneath the lowest point of the pipe. The pipe is installed with the concrete pad before the concrete has cured, the pad extending upwardly to about the centre line of the pipe and thereby contacting the entire lower surface of the pipe.

Prior art bends, traps and other conduits are unable to, on their own, resist fracture upon forceful contact with a blockage clearing tool such as a metal plunger rod. The concrete support increases the fracture resistance of the bend, trap o other conduit such that it will not fracture where a blockage clearing tool impacts the inner wall. The present invention circumvents the need for a concrete support, thereby saving on labour and materials in a drainage installation. Functionally, a plumbing fitting of the present invention may be installed without a concrete support but nevertheless exhibit at least the same fracture resistance as one that has been installed with concrete.

Where the present invention is embodied the form of a seat, the seat may function to provide support to a bend or a trap or other conduit the same or similar to that provided by the concrete support in AS/NZS 3500.2.

The present invention will now be more fully described by reference to the following non-limiting example depicted in the drawings.

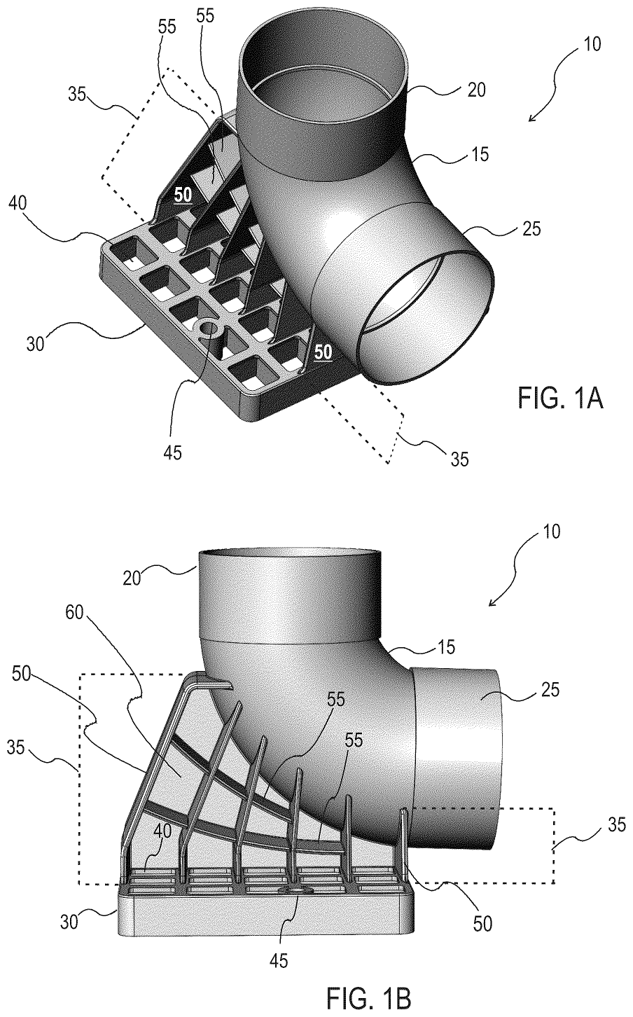

FIG. 1A and FIG. 1B depict a plumbing fitting of the present invention, embodied as an elbow (10) of the type used in a drainage application to convey sewage, storm water or other types of waste water. The elbow (10) comprises a body portion (15) being a curved section of conduit having an inner radius (facing upwardly, as dawn) and an outer radius 9 facing downwardly, as drawn). In a prior art elbow, the wall of the outer radius is typically thinner than that of the inner radius wall. In the present invention, the outer radius wall may be of the same or similar thickness to the inner radius wall. Alternatively, the outer radius wall may be of greater thickness than the inner radius wall.

The elbow (10) comprises an inlet portion (20) which is typically orientated substantially vertically to receive water falling from a drainage source, and an outlet portion (25) typically orientated substantially horizontally to direct water toward a sewer or other destination. As will be appreciated, water is conveyed to and from the elbow (10) by pipes (not drawn) connected thereto. Each of the inlet (20) and outlet (25) portions being slightly dilated and thereby configured to accept respectively an inlet pipe (not drawn) and an outlet pipe (not drawn).

Formed integrally with the body portion (15) is a base portion (30) and a supporting portion (35).

The base portion (30) is formed as a generally grid-like structure providing a series of spaces (40). An aperture (45) is formed within the base portion (30),

The supporting portion (35) is embodied as a framework comprising a series of connecting members (the first and last of the series being marked 50) which connect the base portion (30) to the body portion (15). The framework further comprises cross members (55). The framework is bisected by a wall (60), which may be hollow or solid

Having now described the structural components of the elbow (10), the function of each will now be described.

The thickened external radial wall (70) of the body portion of the fitting (10) provides for improved resistance to impact and other damaging forces. The thickened wall (70) also provides for a more robust connection of the body portion (15) with the connecting members (50) such that forces applied to the inner side of the wall (70) are more fully transferred to the filling material disposed in the spaces (60).

The base portion (30) functions to provide a stable platform to keep the elbow (10) as a whole from moving during and after installation In a drainage system installation, a trench is typically dug and the elbow is located on the trench floor, the base portion (30) making contact therewith. In prior art fittings the base is of relatively small area, thereby leaving the connection fitting as a whole liable to movement both during and after installation. The base portion (30) in the present fitting is large relative to the body portion (15). Movement in the base (30) during installation can alter the fall in a horizontal pipe set by the installer, and where that alteration is noticed necessitates corrective work by the installer. Where the alteration in fall is not noticed the system as a whole may fail to properly drain.

The base portion (30) comprises spaces (40) which prevent water from collecting about the elbow (10). Rain water filtering through the soil and filling material surrounding the drainage system would settle on the base portion (30) but for the presence of the spaces (40) which allow water to drain downwardly and away from the elbow (10). The ability for water to drain may prevent to some degree movement of soil or filling material, and in turn prevent movement of the elbow (10). As will be appreciated, all components of a drainage system should experience little or substantially no movement after installation to prevent stresses from being placed on the various components and joins and also to ensure correct fall is maintained.

The base portion (30) has the further function of providing a structure from which the supporting portion extends. The increased area of the base portion (30) in the present invention spreads load from the various fittings and pipes thereabove (via the supporting portion (35)) leading to improved support of all components. The smaller base portion of the prior art concentrates the same load onto a smaller base area, and where the underlying substrate is not completely solid leads to sinking of the elbow (10) and all components attached thereto.

The supporting portion (35) maintains the body portion (15) in spaced relation to the base portion (30). The base portion (30) and supporting portion (35) together suspend the body portion (15) above the trench floor. Accordingly, a space is provided between the trench floor and the lower surface of the body portion (15). When the elbow (10) is securely connected to the inlet and outlet pipes, the trench is back filled, the space between the trench floor and the lower surface of the body portion (15) accepting the filling material. Typically, the filling material is compacted to some extent by the installer. Preferably, the supporting portions provides a distance between the base (30) and the body portion (15) of at least about 30 mm, 40 mm, 50 mm, 60 mm, 70 mm, 80 mm, 90 mm, 100 mm, 110 mm, 120 mm, 130 mm, 140 mm, 150 mm, 160 mm, 170 mm, 180 mm, 190 mm and 200 mm. Increasing distances allow for greater volumes of filling material to be retained between the base portion (30) and body portion (15). The increasing volumes in turn allow for engagement of the elbow (10) with larger volumes of filling material thereby providing for greater stability.

In prior art fittings the distance spanned by any supporting portion is relatively short, and generally insufficient to accept and retain a significant amount of filling material between the base and body portions. Accordingly, prior art fittings are less capable of engaging with any significant amount of filling material disposed thereabout, and accordingly the fitting is more prone to instability and movement.

In the preferred embodiment of the drawings, the filling material moves laterally from adjacent to supporting portion (35) and into the spaces within the framework of the supporting portion (35). Compaction forces the filling material up against the wall (60). The framework members (50) (55) have broad faces that function to retain the filling material within the framework. The compacted filling material in the upper spaces of the framework bear against and support the lower wall (i.e. the outer radius) of the body portion (15). Compacted filling material in the lower spaces of the framework support frame members in the upper part of the framework, and in turn the compacted fill material in the upper part of the framework.

In some embodiments, a material comprising particulates in a defined size range is used as a filling material. For example, the filling material may comprise particles of about 7 to 10 mm in size, and in which case any space or region that must accept the screed must be sized so as to allow for entry of the particles within that size range. Exemplary form of filling material include scoria, blue metal, quarter minus, sewer drain/bedding rock material and aggregate.

Thus, the compacted fill material that is retained below the outer radius of the body portion (15) acts to support the outer radius wall, thereby lessening the possibility of damage to that wall by impact with a drain clearing implement. The compacted material functions in a sense analogously to the concrete used in prior art installations to embed and support the elbow.

In the preferred embodiment of the drawings the base portion (30) has the further function of retaining filling material within the spaces (40). That retained material interfaces with the underlying substrate, filling material above and lateral to the base portion so as to more securely retain the elbow (10) as a whole in position

In some embodiments, the supporting portion (35) has a structural role being configured to assist in supporting the outer radius of the body portion (15) so as to limit damage by impact from a drain clearing implement. In other embodiments, the supporting portion is configured to provide the majority of the support to the outer radius of the body portion. In yet further embodiments the supporting portion is configured to provide substantially all of the support to the outer radius of the body portion. As will be appreciated, elements of the supporting portion (35) may be formed so as to provide greater levels of support, with an example being thickening of the framework members. A further example may be to dispose the frame work members at a higher density.

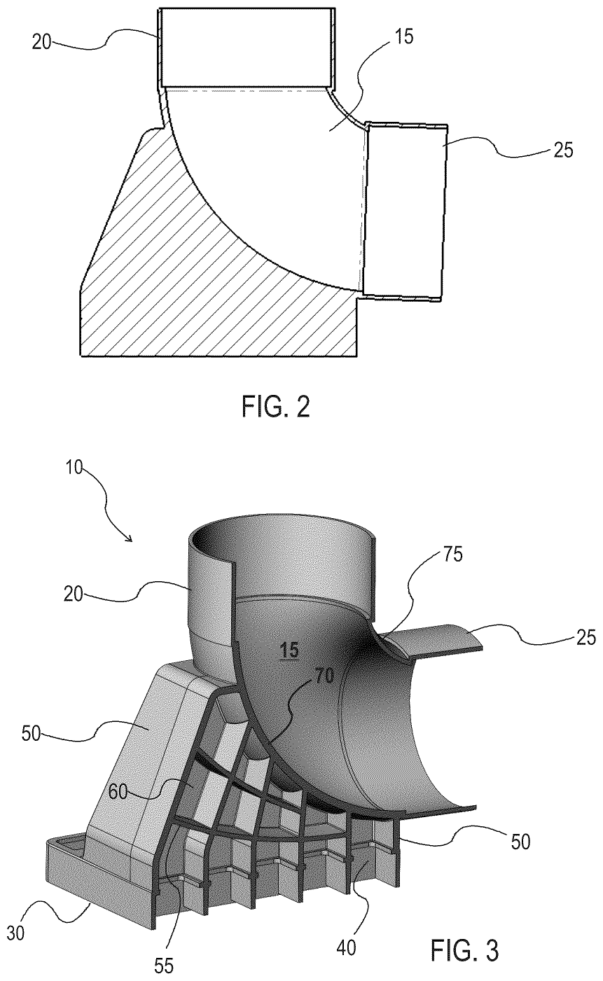

Reference is made to FIG. 2, depicting diagrammatically the volume (shaded area) beneath the body portion (15) comprising a combination of filling material, base portion (30) and supporting portion (35) that together contribute to supporting the outer radius wall of the body portion (15).

Turning now to FIG. 3, the outer radius wall (70) of the body portion (15) is thickened (to about 5 mm) compared to the inner radius wall (75) (about 2.5 mm). In this embodiment, the thickened outer radius wall assists in resisting damage caused by the impact of a drain blockage clearing implement.

The preferred embodiment of the drawings is suitable also for installation in an above-ground environment. For example, the elbow may be installed within a building to receive a vertical drainage pipe originating in an upper floor and terminating in a lower floor or even below the building. Such lengthy vertical expanses if pipe are heavy, and place significant stress on an elbow. The present elbow may be suspended on a hanger, such as “all thread”. A length of all-thread extends through each of the apertures (45) in the base portion (30). A nut (optionally with washer) is wound onto the all-thread to support the base portion (30) and therefore the entire elbow (10) at a desired level. By this arrangement, the base portion (30) assumes a large portion of the load forces that would otherwise be exerted on an elbow. The body portion (15) of the present elbow (10) is therefore placed under less stress, and may therefore be less prone to damage.

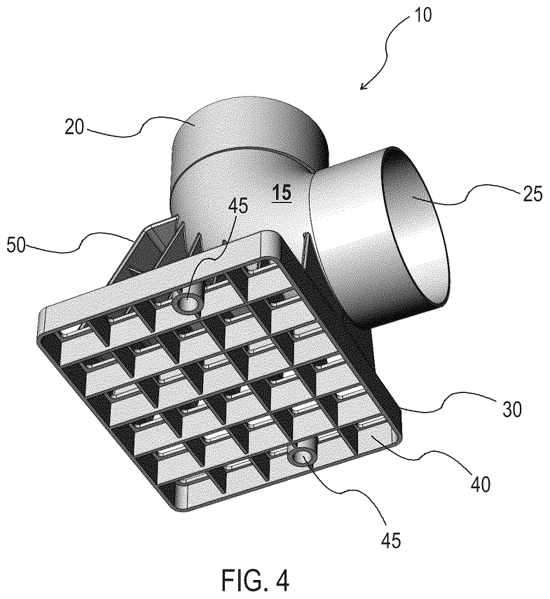

Reference is made to FIG. 4 showing more clearly the apertures (45) extending through to the lower side of the base portion (30) to allow a length of all-thread (not drawn) to extend therethrough.

The apertures (45) may also be useful in the installation of the elbow (10) in a drainage trench. Pegs may be hammered through the apertures (45) and into the soil below thereby more firmly securing the elbow in place, and preventing movement during installation.

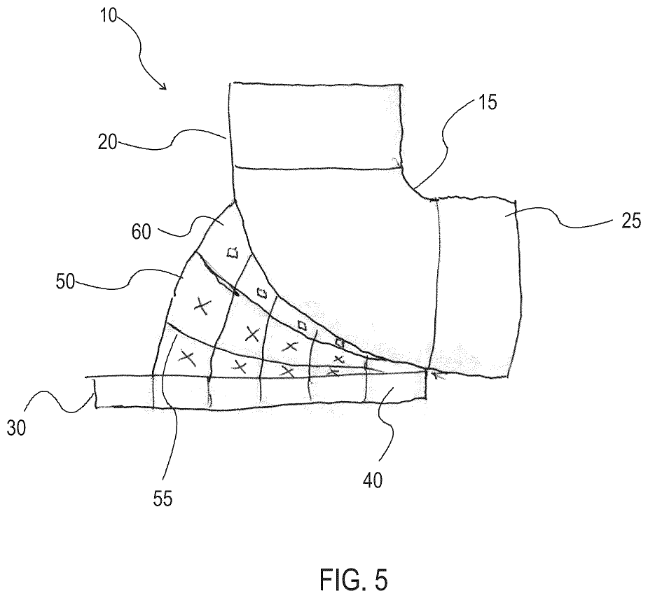

Reference is now made to FIG. 5 showing an alternative preferred embodiment of the invention. In this embodiment, the wall (60) is partially removed or completely removed to allow filling material to extend continuously across the region between the base portion (30) and the body portion (15). This may have the effect of further improving engagement of the elbow (10) with the surrounding filling material. FIG. 5 shows the wall to be absent in the areas marked “x” and present in areas marked “□”. It is further proposed that removal of the wall (60) of part thereof provides a cost saving as a result of lesser material quantities used in fabrication.

Staying with the alternative preferred embodiment of FIG. 5, that embodiment differs to the embodiment of the previous drawings in that the framework members (50) are shortened. This may provide for a more direct transfer of forces from the body portion (15) to the base portion (30). A further advance is a cost saving in materials used in fabrication. It is proposed that the lesser amount of filling material beneath the right-most (as drawn) region of the body portion (15) may not dramatically impact the operation of the elbow (10), given that the majority of impact or damage will likely be occasioned on the more central region of the body portion (15) where large volumes of supportive filling material remain.

It is contemplated that the present invention may be embodied in the form of the base portion and supporting portion only, with those portions being applied to an existing separate plumbing conduit. The supporting portion may simply receive the separate plumbing conduit, the conduit sitting on the supporting portion. Alternatively, the supporting portion may be configured to actively engage with the plumbing conduit by way of a pressure fit, an applied adhesive, a lash, a strap, a tie, or similar.

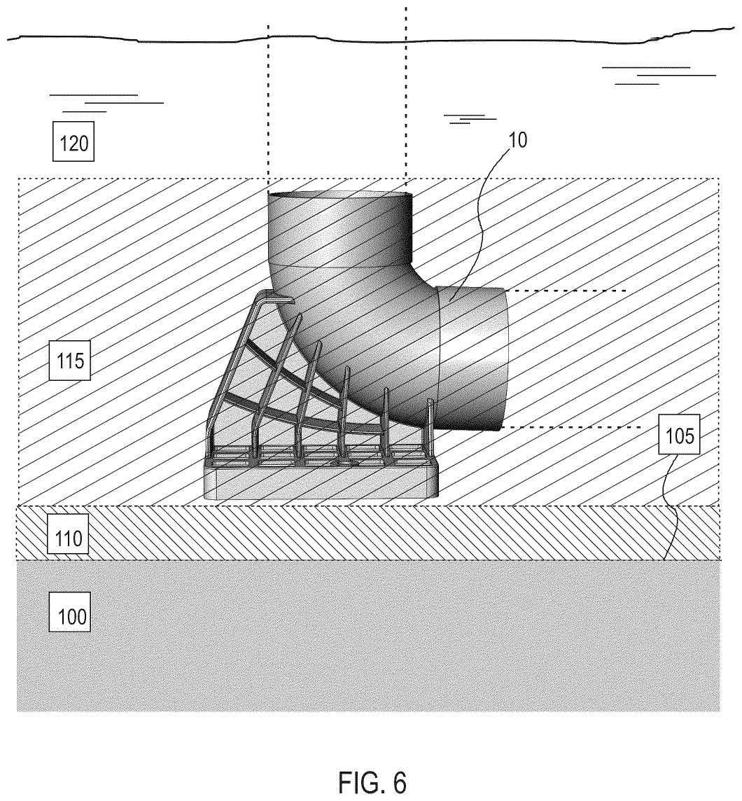

Reference is now made to FIG. 6 showing a preferred installation of the elbow of FIG. 1A. the inlet an outlet pipes are represented by the dashed lines. The area (100) represents the existing soil from which the draining trench is dug. The floor of the trench is marked (105). The first step of the installation involves laying filling material (110) to a depth of about 50 mm to 100 mm on the trench floor (105). The elbow (10) is then disposed on top of the filling material layer (110) and the inlet and outlet pipes connected thereto. Further filling material is added about the elbow (10) and pipes. Backfill is used to fill the remainder of the trench. It is typical for the installer to use mechanical or manual compaction after a new layer is added to the trench. In the compaction process filling material is forced into the spaces between the frame members (50, 55), and also the spaces (40) in the base portion (30) thereby stabilising the elbow (10) as a whole.

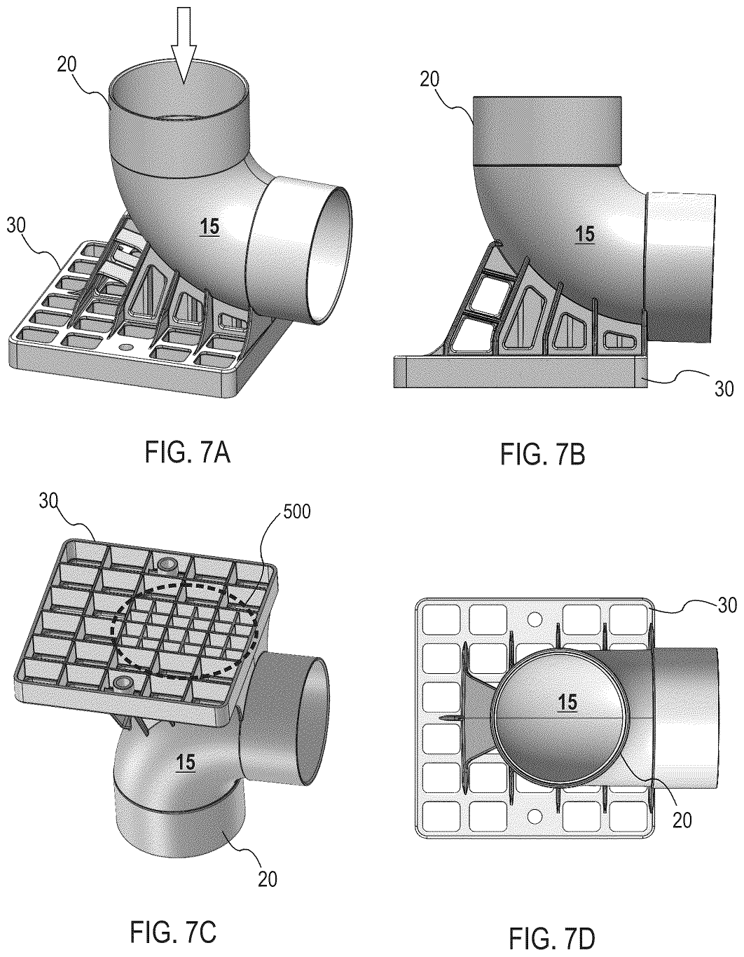

Reference is made to the embodiment illustrates in FIG. 7A, FIG. 7B, FIG. 7C and FIG. 7D. This embodiment comprises a region (500) where the framework members (50) are more closely spaced than the remainder framework members. The region (500) is disposed immediately below a wall of the body portion (15) that is a potential blockage clearing tool impact zone. For example, a rigid metal plunger tool may be forcibly pushed vertically downward through the inlet portion (20) as indicated by the arrow in FIG. 7A in order to clear a blockage in the body portion (15). The tip of the plunger impacts a small area of the body potion (15) wall (less than, say 50 mm²), potentially fracturing the wall. The closely spaced framework members in region (500) act to better resist the impact force by providing greater support for the wall from beneath. The remainder framework members (i.e. those outside the region (500)) are not required to assist in fracture resistance and accordingly are less closely spaced, thereby providing a saving in material.

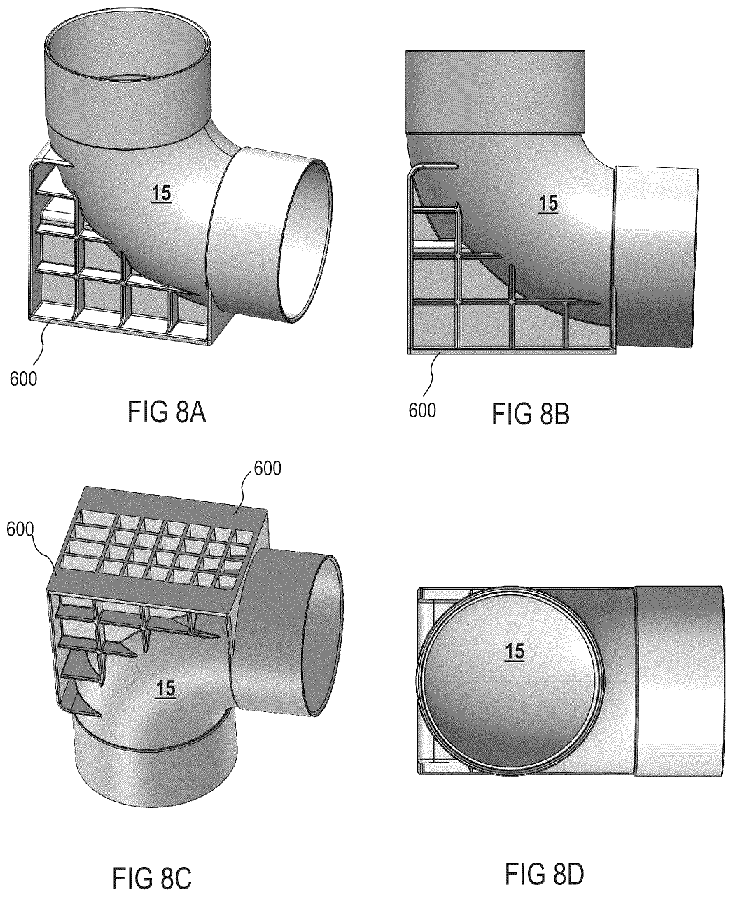

The embodiment of FIG. 8A, FIG. 8B and FIG. 8C is devoid of the obvious base (30) shown in the earlier drawn embodiments. The lower planar structures (600) may be considered as a base. Alternatively, this embodiment may be considered as being devoid of a base.

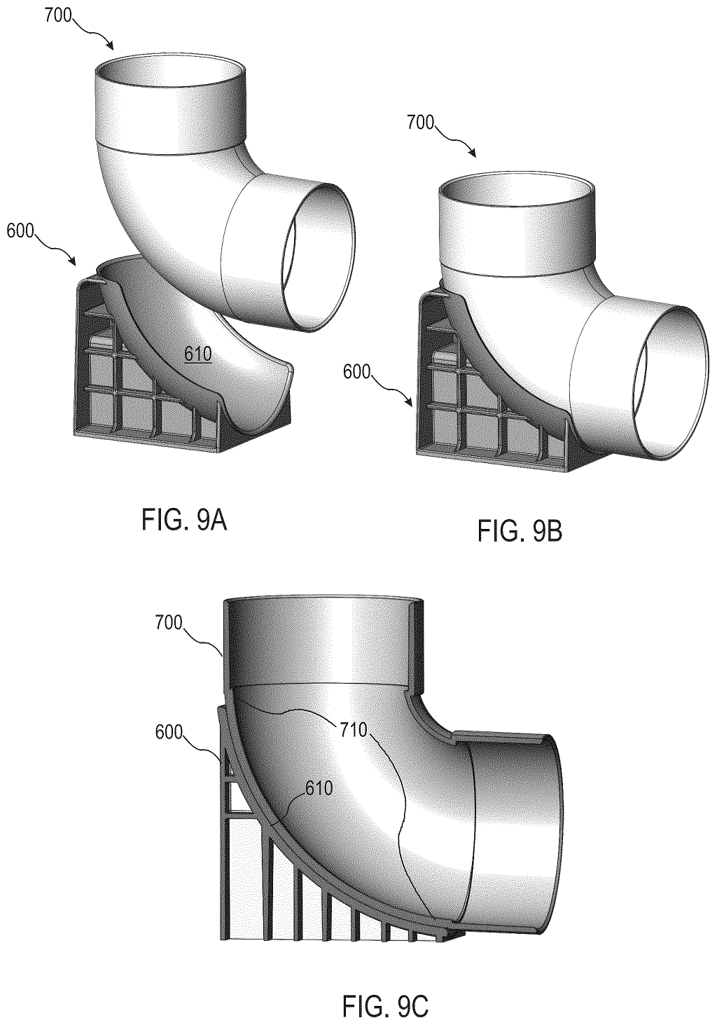

Reference is now made to FIG. 9A, FIG. 9B and FIG. 9C. An alternative aspect of the present invention is a seat (600) used to support a separate plumbing conduit (700) such as a bend. Together, the seat (600) and plumbing conduit (700) function in the same manner as the integral plumbing fitting of the earlier drawn embodiments. The embodiment of FIG. 9A, FIG. 9B and FIG. 9C may therefore incorporate any one or more features of the integral plumbing fitting described and drawn herein. As will be noted from the second view of FIG. 9C, a region (710) of the plumbing conduit (700) is thickened. The region (710) directly contacts the cradle (610) of the seat (600). Together the thickened region (710) and cradle (610) provide fracture resistance.

As will be appreciated from the disclosure supra, an advantage of some embodiments of the present invention is limitation or prevention of movement of the connecting fitting and other components of a drainage system. Undesired movement may occur during installation or after installation is complete.

Prevention of movement is of significant advantage in maintaining the 98% fall in horizontal pipes of a drainage system. Further advantage may be provided in that movement of drain system components is prevented or limited. For example, movement in an unstable fitting may alter the height of an above-ground inspection riser away from that desired during backfilling. Improved stabilisation provided by the elbow (10) assists in minimising or completely preventing any horizontal or vertical movement of a riser. Advantageously, the need for additional bends on a riser to bring the waste back into the correct position after backfilling may be removed.

Furthermore, stabilisation of the elbow secures it in the correct position when laying a drainage system and installing the correct pipe length, as the elbow is fixed in the correct position.

Discussion of any feature, any combination of features, or any feature alternatives in relation to the preferred embodiment of the drawings should not be taken as applicable only to that preferred embodiment. Any feature, any combination of features, or any feature alternatives may be applied to any embodiment of the invention described and/or claimed herein.

Those skilled in the art will appreciate that the invention described herein is susceptible to further variations and modifications other than those specifically described. It is understood that the invention comprises all such variations and modifications which fall within the spirit and scope of the present invention.

While the present invention is described herein by reference to an elbow used in drainage applications, it will be apparent to the skilled person having the benefit of the present specification may be applicable to other types of plumbing fitting. For example, the invention may be applied to a substantially U-shaped trap in which case the supporting portion contacts the lower curved surface of the U-shape, and the base has a greater area.

Alternatively, the plumbing fitting may comprise a sharp corner rather than a bend.

It is further contemplated that the invention could be applied to a plumbing connector has an inlet and outlet forming an obtuse angle, or even a straight angle.

The invention may be applied to a plumbing fitting that is a simple length of pipe that requires support at any point along its length for any reason.

The invention may be further applied to a junction for connecting three or more pipes.

The present invention may provide environmental benefits by potentially saving around 15 bags of concrete (10 bends×15×20 kg=15 Bags) for a typical class 1 building. The cement industry accounts for 8% of all CO₂ emissions, and so use of the present invention to obviate the need for concrete support has clear environmental advantages. Moreover, the present invention may be fabricated from recycled materials (such as PVC), which may be then further recycled into new products when a building is demolished.

Occupational Health and Safety benefits may also be provided by eliminating the need for workers to be exposed to concrete dust prior to mixing. Moreover, there is a reduction in physical stress and trip hazards arising from workers carrying 20 kg concrete bags and buckets of mixed concrete about building sites and trenches. The reduction in injury risk is a significant benefit to the construction industry.

Consumer may benefit from a higher likelihood of a plumbing fitting being properly installed at first instance. In the prior art, the requisite depth of concrete may not be used however with the present invention it is certain that a fitting will be properly supported. Accordingly, a consumer is less likely to have a drain damaged in the course of a blockage clearing exercise.

Consumers benefit from better guarantee on a correct installation by plumber. Protection during maintenance or repair works. The present invention may reduce or eliminate costly repairs to broken bends that have been incorrectly installed, and therefore are insufficiently supported.

The spirit and scope of the present invention is not to be limited by the foregoing, but is to be understood in the broadest sense allowable by law.

1. A plumbing fitting for use in a domestic drainage application, the plumbing fitting comprising:
a body portion having a liquid inlet and a liquid outlet, the body portion configured to alter a direction of a liquid being conveyed therethrough,
a base portion configured to sit on a substrate,
a supporting portion extending between the body portion and the base portion, and
the body portion, the base portion and the supporting portion each being fabricated predominantly or completely from a synthetic polymer,
wherein the body portion is resistant to fracture upon contact with a blockage clearing tool when used to clear a blockage therein.

2. The plumbing fitting of claim 1, wherein the resistance to fracture is sufficient such that cement, concrete, or a functionally equivalent material is not required to support the body portion.

3. (canceled)

4. (canceled)

5. (canceled)

6. (canceled)

7. The plumbing fitting of claim 1, wherein the supporting portion is integral with the body portion.

8. (canceled)

9. The plumbing fitting of claim 1, wherein the supporting portion comprises spaces configured to save in an amount of material used in fabrication and/or to save in weight.

10. The plumbing fitting of claim 1, wherein the supporting portion is formed from one or more downwardly extending members configured to transfer a force occasioned on the body portion by a blockage clearing tool to a substrate beneath the body portion.

11. The plumbing fitting of claim 10, wherein the one or more downwardly extending members form a framework.

12. The plumbing fitting of claim 11, wherein the framework is in the form of a lattice-like arrangement.

13. (canceled)

14. The plumbing fitting of claim 1, wherein the supporting portion and/or the base portion provide or contributes one or more spaces configured to allow a filling material introduced about the plumbing fitting during installation to enter thereinto.

15. (canceled)

16. (canceled)

17. The plumbing fitting of claim 1, wherein the supporting portion is configured so as to not present a broad face directed in a manner that would prevent or inhibit the movement of a filling material introduced about the plumbing fitting during installation into a space of the supporting portion.

18. The plumbing fitting of claim 1, wherein the supporting portion comprises a plurality of framework members each of which has a broad face, and wherein each of the broad faces are generally arranged, aligned or angled to allow movement of a filling material into the spaces between the framework members.

19. (canceled)

20. The plumbing fitting of claim 1, wherein each of the body portion, the supporting portion, and the base portion has a foot print in plan view, and
the base portion footprint is at least about 100%, 105%, 110%, 115%, 120%, 125%, 130%, 135%, 140%, 145%, 150%, 155%, 160%, 165%, 175%, 180%, 185%, 190%, 195% or 200% the footprint of the body portion, or the supporting portion.

21. The plumbing fitting of claim 20, wherein in plan view the majority of body portion footprint is located within the majority of the base portion footprint.

22. (canceled)

23. (canceled)

24. (canceled)

25. The plumbing fitting of claim 1, wherein the body portion is configured to connect two conduits.

26. The plumbing fitting of claim 25 that is configured to alter the direction of the flow of liquid originating in one of the two conduits, or to divide the liquid originating in one of the two conduits, or to allow the inspection of liquid originating in one of the two conduits.

27. The plumbing fitting of claim 1, selected from: a boundary trap, a disconnector gully trap, a junction, an elbow, a bend and an inspection piece.

28. (canceled)

29. The plumbing fitting of claim 1, wherein the filling material is composed of particles having a maximum dimension of no larger than about 10 mm and/or no smaller than about 7 mm.

30. (canceled)

31. (canceled)

32. (canceled)

33. The plumbing fitting of claim 1, wherein the synthetic polymer is polyvinyl chloride (PVC), unplasticized polyvinyl chloride (UPVC), acrylonitrile butadiene styrene (ABS), fibre-reinforced plastic (FRP), or high density polyethylene (HDPE).

34. (canceled)

35. The plumbing fitting of claim 1, wherein the body portion is a bend or an elbow.

36. (canceled)

37. (canceled)

38. The plumbing fitting of claim 1, configured such that a wall of the body portion and/or the supporting portion provides or contributes to resistance to fracture against a pressure or a tension of at least about 10, 11, 12, 13, 14, 15, 16, 17, 18, 19, 20, 21, 22, 23, 24 or 25 MPa.

39. (canceled)

40. (canceled)

41. A seat for supporting a plumbing conduit for use in a domestic drainage application, the plumbing conduit having a liquid inlet and a liquid outlet, the plumbing conduit configured to alter a direction of a liquid being conveyed therethrough, the seat comprising:
a base portion configured to sit on a substrate,
a contoured upwardly facing contact surface configured to conform to an external surface of the plumbing conduit
a supporting portion extending between the body portion and the contact surface,
the contact surface, the base portion and the supporting portion each being fabricated predominantly or completely from a synthetic polymer
wherein the supporting portion is configured to contribute a resistance to fracture to the plumbing conduit caused by contact with a blockage clearing tool when used to clear a blockage therein

42. (canceled)

43. (canceled)

44. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)
